(19) United States
(12) Patent Application Publication
(10) Pub. No.: US 2026/0039499 A1
(43) Pub. Date: Feb. 5, 2026

(54) METHODS AND SYSTEMS FOR ESTIMATING REQUIRED TRANSMIT POWER

(71) Applicant: Comcast Cable Communications, LLC, Philadelphia, PA (US)

(72) Inventors: Robert HOWALD, Sanford, FL (US); Richard PRODAN, Niwot, CO (US); John CHROSTOWSKI, WARRINGTON, PA (US); HsinChih LIN, Bensalem, PA (US); Takashi HAYAKAWA, Superior, CO (US)

(21) Appl. No.: 19/288,843

(22) Filed: Aug. 1, 2025

Related U.S. Application Data
(60) Provisional application No. 63/678,467, filed on Aug. 1, 2024.

(51) Int. Cl. H04L 12/28; H04L 12/12

(52) U.S. Cl. CPC H04L 12/2801; H04L 12/12

(57) ABSTRACT

Methods and systems for estimating required transmit power are disclosed. First information indicative of a transmit power associated with upstream signals transmitted by a first device, located at a premises, to a network node via a first upstream frequency band may be received. Second information indicative of a frequency response and received signal levels associated with downstream signals received by the first device from the network node via a downstream frequency band may be received. A transmit power necessary for a second device located at the premises to transmit one or more upstream signals to the network node, via a second upstream frequency band, to achieve a threshold receive power at the network node may be estimated based on the first information and the second information. The second upstream frequency band may at least partially overlap the downstream frequency band.

### CROSS-REFERENCE TO RELATED APPLICATIONS

This application claims priority to and the benefit of U.S. Provisional Application No. 63/678,467, filed Aug. 1, 2024, the disclosure of which is hereby incorporated by reference in its entirety.

### BACKGROUND

A device, such as a modem device or a gateway device, may need to be installed at a premises to deliver one or more services to a user located at the premises. Prior to installation of the device, it may be desirable to estimate a power at which the device, if the device were to be installed at a location at the premises, would be required to transmit upstream signals in order for a network node to receive the upstream signals at or above a threshold receive power.

### SUMMARY

Systems and methods for estimating a required transmit power are described herein. A first device may be installed at a customer premises. The first device may comprise a device that transmits upstream signals to a network node via an upstream frequency band and receives downstream signals from the network node via a separate, downstream frequency band. The customer may want to upgrade from the first device to a second device that transmits upstream signals over a wider frequency band. The wider upstream frequency band used by the second device may overlap, at least partially, with the downstream frequency band used by the first device. Because of this frequency band overlap, information associated with the downstream frequency band of the first device may be used to estimate a power at which the second device, if the second device were to be installed at approximately the same location at the premises at which the first device is installed, would be required to transmit upstream signals in order to enable the network node to receive the upstream signals at or above a threshold receive power. If the second device is capable of transmitting at or above the estimated required transmit power, this may indicate that the second device is a good candidate for self-installation by the customer. If the second device is a good candidate for self-installation, a technician may not need to be dispatched to perform a professional installation of the second device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2 is an example bandwidth allocation.

FIG. 3 is an example frequency response.

FIG. 4 is example bandwidth allocation.

FIG. 5A is an example method.

FIG. 5B is an example method.

FIG. 5C is an example method.

FIG. 6 is an example method.

FIG. 7 is an example method.

FIG. 8 is an example computing device.

### DETAILED DESCRIPTION

A device, such as a cable modem or a gateway device, may be used to deliver one or more services, such as broadband service, to a premises (e.g., a customer's home, business). Customers may prefer to self-install the devices at their own premises. To enable a customer to self-install a device at his or her own premises, a get started kit (GSK) may be shipped to the premises. The GSK may include the device, any other necessary devices (e.g., a set-top box), cabling, splitters, power cords, instructions, and/or the like. If customers successfully self-install the devices at their own premises, this may provide significant operational benefits and savings to the entity that would otherwise be responsible for dispatching technicians to a large number of premises for installing the devices.

While self-installation is preferred, the self-installation process is becoming increasingly difficult as service demands evolve and newer devices built to accommodate these demands. Newer devices may be compliant with the Data Over Cable Service Interface Specification (DOCSIS) 4.0 standard. The DOCSIS 4.0 standard uses a significantly wider upstream band than earlier versions of DOCSIS, such as DOCSIS 3.0 and 3.1. For example, DOCSIS 3.1 uses channel bandwidths of up to 85 megahertz (MHZ) in the upstream, while DOCSIS 4.0 uses channel bandwidths of up to 684 MHz in the upstream. The higher upstream frequencies associated with DOCSIS 4.0 may incur higher radio frequency (RF) path loss between the device and a receiving node in a coaxial or hybrid fiber-coaxial (HFC) plant. A device compliant with the DOCSIS 4.0 standard (which may be referred to herein as a “DOCSIS 4.0 device”) may have the same total available transmit power to use over this much wider bandwidth. As a result, if the transmit power capacity of the DOCSIS 4.0 device has been reached, the power spectral density (PSD) of the DOCSIS 4.0 device must decrease to accommodate the increased bandwidth.

However, if the PSD decreases too much, the DOCSIS 4.0 device may be unable to range and register with the receiving node and/or a virtualized cable modem termination system (vCMTS), or may do so only partially. If the DOCSIS 4.0 device is unable to fully range and register with the receiving node or vCMTS, the customer may experience degraded service, or no service at all. Because of these complications, the specification reference architecture for the DOCSIS 4.0-enabled home defaults to a pro-installation (e.g., a technician visiting a premises to create the reference architecture), even though some DOCSIS 4.0 devices are still good candidates for self-installation. As such, techniques for determining whether or not a DOCSIS 4.0 device is a good candidate for self-installation are needed.

Described herein are techniques for determining whether a DOCSIS 4.0 device is a good candidate for self-installation. DOCSIS 4.0 Full-Duplex (FDX) is based on technology that allows for part of the coaxial spectrum to be used as either downstream or upstream, or both simultaneously, which is different from how earlier versions of DOCSIS used the coaxial spectrum (e.g., part of it used for downstream, and a much smaller part of it used for upstream). A DOCSIS 4.0 device may therefore be transmitting upstream signals in spectrum that can also be used for downstream signals.

This bi-directional spectrum feature has benefits that may be used to determine if a DOCSIS 4.0 device is a good candidate for self-installation. The last active device before the drop cable that leads to a premises (e.g., the receiving node) may have an RF configuration that is known (e.g., either digitally or design prints). Further, an existing device compliant with DOCSIS 3.0 or DOCSIS 3.1 (collectively referred to as “an existing non-DOCSIS 4.0 device”) at a premises may support a downstream spectrum capture. The downstream spectrum capture may be routinely polled (e.g., twice daily) as part of standard proactive maintenance operations. The downstream spectrum capture may indicate a signal level versus frequency for the non-DOCSIS 4.0 device across the entirety of the downstream bandwidth. The known RF configuration for the receiving node and the downstream spectrum capture may be used to measure the downstream path loss (e.g., attenuation) associated with the non-DOCSIS 4.0 device and the frequency response (e.g., signal level versus frequency) of the downstream path loss.

Because the DOCSIS 4.0 FDX band (e.g., 108-684 MHZ) is both a downstream and an upstream band, and is nearly symmetrical, the downstream frequency response and path loss associated with the non-DOCSIS 4.0 device may be the same as, or approximately the same as, the frequency response and the path loss in the DOCSIS 4.0 FDX upstream band (if the DOCSIS 4.0 device were to be installed at approximately the same location at the premises at which the non-DOCSIS 4.0 device is currently installed). The path loss and frequency response in the DOCSIS 4.0 FDX upstream band, as determined by the non-DOCSIS 4.0 device downstream band telemetry, may be used to estimate a transmit power that would be necessary for a DOCSIS 4.0 device, installed at approximately the same location at the premises at which the non-DOCSIS 4.0 device is currently installed, to transmit upstream signals to the receiving node via the DOCSIS 4.0 FDX upstream band in order to achieve a threshold receive power at the receiving node. If the DOCSIS 4.0 device is capable of transmitting upstream signals at or above the estimated transmitted power, it may be estimated that all speeds that the system is designed to support can be supported. If it is estimated that all speeds that the system is designed to support can be supported, this may indicate that the DOCSIS 4.0 device is a good candidate for self-installation.

If the DOCSIS 4.0 device is not capable of transmitting upstream signals at or above the estimated transmitted power, this may indicate that the DOCSIS 4.0 device is not a good candidate for self-installation. If the DOCSIS 4.0 device is not a good candidate for self-installation, a pro-installation of the DOCSIS 4.0 device may need to be performed. Alternatively, even if the DOCSIS 4.0 device is not capable of transmitting upstream signals at or above the estimated transmit power, if it is determined that the DOCSIS 4.0 device is capable of transmitting upstream signals at a level that can produce a speed that satisfies a speed tier associated with (e.g., selected by) the customer, the DOCSIS 4.0 device may still be a good candidate for self-installation. If the DOCSIS 4.0 device is not capable of transmitting upstream signals at or above the estimated transmit power and the DOCSIS 4.0 device is not capable of transmitting upstream signals at or above a level that can produce a speed that satisfies the speed tier associated with (e.g., selected by) the customer, this may indicate that the DOCSIS 4.0 device is not a good candidate for self-installation and that a pro-installation of the DOCSIS 4.0 needs to be performed.

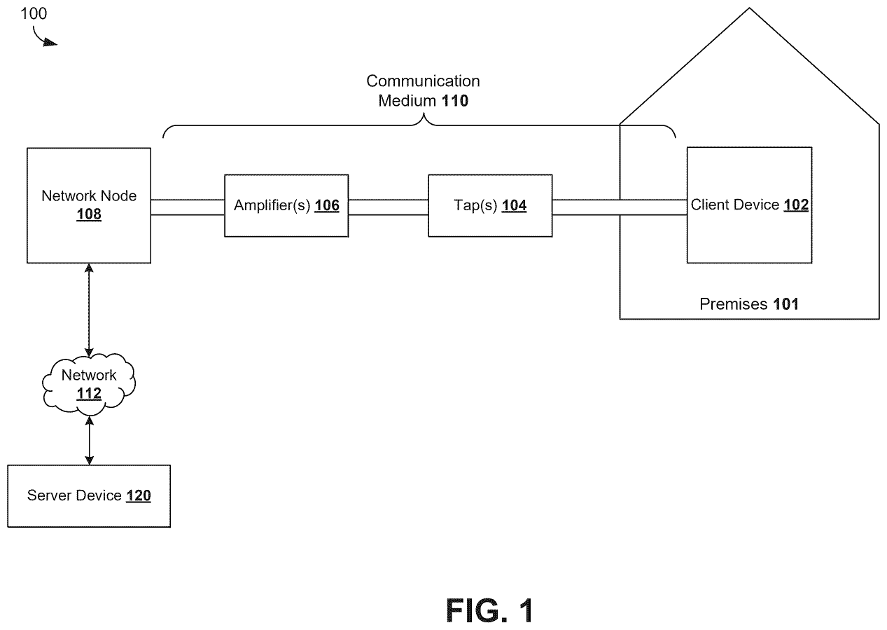

FIG. 1 is an example system 100. The system 100 may comprise a network node 108, a client device 102, and a server device 120. The client device 102 may be located at a premises 101. The premises 101 may comprise a property, dwelling, terminal, building, floor, and/or the like. The client device 102 may be installed at a location at a premises 101, such as in a particular room at the premises 101. The client device 102 may be in communication with the network node 108 via a communication medium 110. The communication medium 110 may comprise, for example, a coaxial cable connection, or a HFC cable connection between the network node 108 and the premises 101. The coaxial cable or HFC cable connection may comprise one or more RF amplifiers 107 and one or more taps 104. The network node 108 may comprise a distributed access architecture (DAA) node. The network node 108 may receive fiber input and output electrical signals onto a coaxial cable. The amplifier(s) 107 may repeat the electrical signals until the electrical signals reach a tap 104 that is connected to the cable drop associated with the premises 101.

The client device 102 may be used to deliver one or more services, such as broadband service, to the premises 101. The client device 102 may comprise any computing device, such as a modem, a gateway device, or a router device, that is compliant with a version of DOCSIS that predates DOCSIS 4.0. For example, the client device 102 may comprise a client device that is compliant with DOCSIS 3.0 or DOCSIS 3.1. The client device 102 may be configured to transmit upstream signals to the network node 108 via a first upstream frequency band of the communication medium 110. The client device 102 may be configured to receive downstream signals from the network node 108 via a downstream frequency band of the communication medium 110. The first upstream frequency band and the downstream frequency band may comprise different frequency bands, with the first upstream frequency band being smaller than the downstream frequency band.

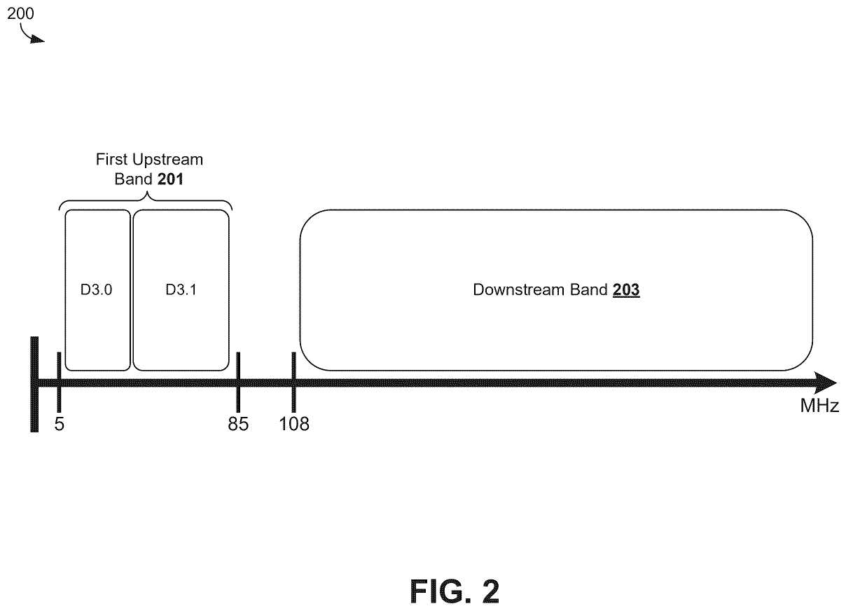

FIG. 2 illustrates an example bandwidth distribution 200 associated with the client device 102. The bandwidth distribution 200 comprises a first upstream frequency band 201 and a downstream frequency band 203. The first upstream frequency band 201 may comprise frequencies in a range of about 5 MHz to 85 MHz. The client device 102 may therefore use channel bandwidths of about 5 MHz to 85 MHz to transmit upstream signals to the network node 108. The downstream frequency band 203 may comprise frequencies in a range of about 100 MHZ (e.g., 108 MHZ) to one gigahertz (GHz) or more (e.g., 1.218 GHZ). The client device 102 may therefore use channel bandwidths of about 100 MHZ (e.g., 108 MHz) to one GHz or more to receive downstream signals from the network node 108.

Referring back to FIG. 1, a customer associated with the premises 101 may desire a data speed that requires replacement of the client device 102 with a different client device (not shown in FIG. 1). For example, the customer may want to upgrade from a modem that is compliant with DOCSIS 3.0 or DOCSIS 3.1 to a modem that is compliant with DOCSIS 4.0. The server device 120 may gather information from the client device 102 and the network node 108 to determine if the customer is able to replace the client device 102 with the different client device themselves (e.g., using a GSK), or if a technician should be dispatched to perform a pro-installation of the different device.

The server device 120 may be communicatively coupled with the network node 108 via one or more networks, such as a network 112 (e.g., a wide area network). The network 112 may comprise any of a variety of types of networks, such as, for example, a coaxial cable network, a fiber-optic cable network, a hybrid fiber-coaxial (HFC) network, a satellite transmission channel, a DSL connection, or the like. The network 112 may comprise fiber, cable, a combination thereof. The network 112 may comprise wired links, wireless links, a combination thereof, and/or the like. The network 112 may comprise one or more networks, such as a wide area network (e.g., the Internet), a cellular network, a Long Term Evolution (LTE) network, one or more service entity networks, and/or the like.

The server device 120 may receive first information. The first information may be indicative of a transmit power associated with upstream signals transmitted by the client device 102 to the network node 108 via the first upstream frequency band (e.g., first upstream frequency band 201) of the communication medium 110. If the client device 102 comprises a modem compliant with DOCSIS 3.0, the first information may be indicative of a transmit power associated with upstream signals transmitted by the client device 102 to the network node 108 via the first upstream frequency band per 6.4 MHz. If the client device 102 comprises a modem compliant with DOCSIS 3.1, the first information may be indicative of a transmit power associated with upstream signals transmitted by the client device 102 to the network node 108 via the first upstream frequency band per 1.6 MHz.

The server device 120 may receive the first information from the network node 108. The network node 108 may receive the first information from the client device 102. The network node 108 may receive the first information from the client device 102 The client device 102 may periodically (e.g., twice per day) send the first information to the network node 108. The client device 102 may periodically send the first information to the network node 108 based on (e.g., in response to) a request message sent to the client device 102. The request message may be sent to the client device 102 by the network node 108. The network node 108 may send the first information to the server device 120 based on (e.g., in response to) receiving the first information from the client device 102.

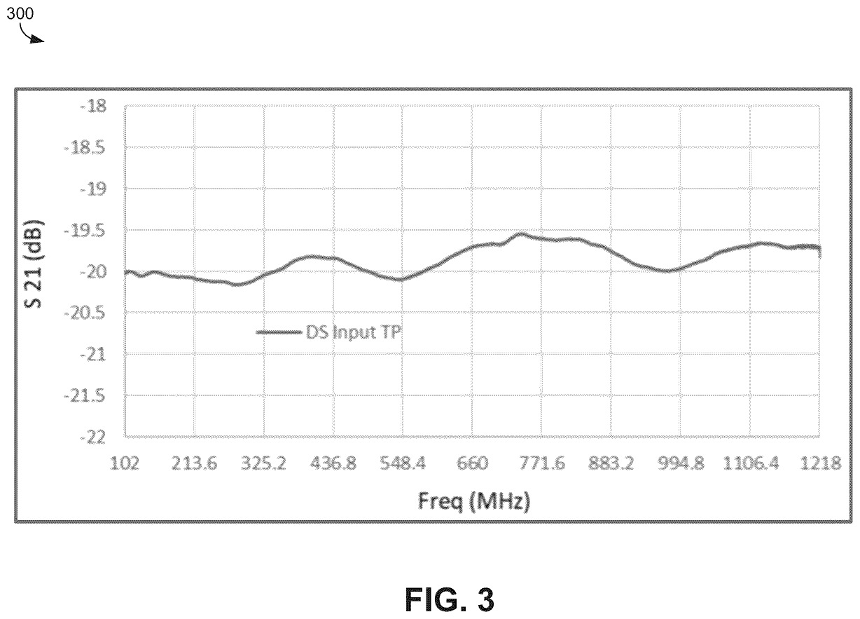

The server device 120 may receive second information. The second information may comprise a full-band downstream spectrum capture (FBC). The second information may be indicative of a frequency response associated with downstream signals received by the client device 102 from the network node 108 via a downstream frequency band (e.g., downstream frequency band 203) of the communication medium 110. FIG. 3 is an example frequency response 300. The frequency response 300 indicates a signal level versus frequency for the client device 102 across the entirety of the downstream frequency band. If the client device 102 is in mid-split mode, the FBC may be captured for frequencies in a range of about 108 MHz to one GHz or more. If the client device 102 is in high-split mode, the FBC may be captured for frequencies in a range of about 258 MHz to one GHz or more.

The server device 120 may receive the second information from the network node 108. The network node 108 may receive the second information from the client device 102. The network node 108 may receive the second information from the client device 102 out-of-band (e.g., via a frequency band that is separate from the first upstream frequency band). The client device 102 may periodically (e.g., twice per day) send the second information to the network node 108. The client device 102 may periodically send the second information to the network node 108 based on (e.g., in response to) a request message sent to the client device 102. The request message may be sent to the client device 102 by the network node 108. The network node 108 may send the second information to the server device 120 based on (e.g., in response to) receiving the second information from the client device 102.

The server device 120 may use the first information and the second information to determine if a customer is able to replace the client device 102 with a DOCSIS 4.0 device themselves (e.g., using a GSK), or if a technician should be dispatched to perform a pro-installation of the DOCSIS 4.0 device. The DOCSIS 4.0 device may comprise any computing device, such as a modem, a gateway device, or a router device, that is compliant with DOCSIS 4.0. The DOCSIS 4.0 device may be configured to transmit upstream signals to the network node 108 and receive downstream signals from the network node 108 via the same frequency band (e.g., the DOCSIS 4.0 FDX band). The DOCSIS 4.0 device may be configured to simultaneously transmit upstream signals to the network node 108 and receive downstream signals from the network node 108 via the same frequency band.

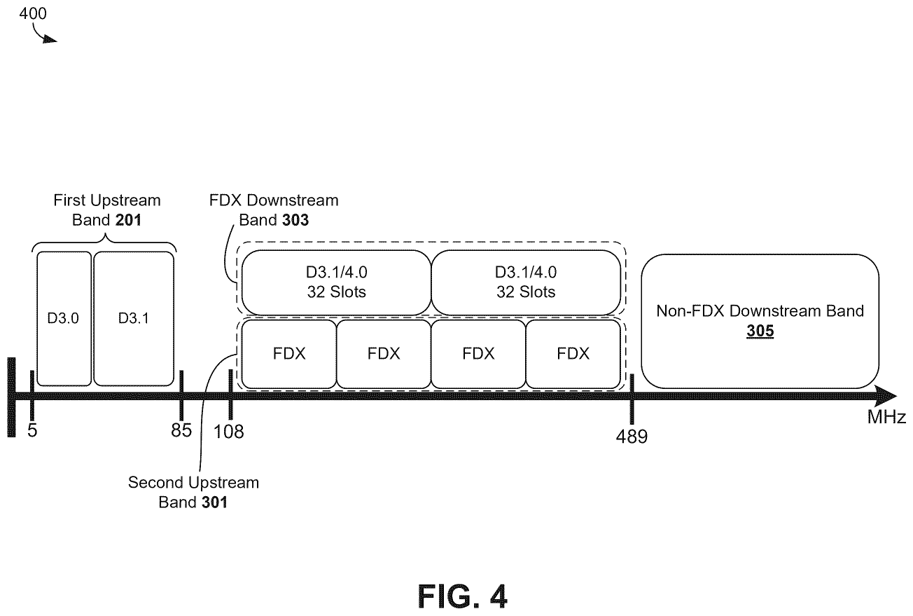

FIG. 4 illustrates an example bandwidth distribution 400 associated with a DOCSIS 4.0 enabled network. The bandwidth distribution 400 comprises the first upstream frequency band 201, which may comprise frequencies in a range of about 5 MHz to 85 MHZ. The bandwidth distribution 400 comprises a second upstream frequency band 301. The second upstream frequency band 301 may comprise the FDX upstream frequency band. In the example of FIG. 4, the second upstream frequency band 301 comprises frequencies in a range of about 108 MHz to 492 MHz and the non-FDX downstream band 305 comprises frequencies above 492 MHz. However, it should be appreciated that the second upstream frequency band 301 may instead comprise frequencies in a range of about 108 MHZ to 684 MHz. The bandwidth distribution 400 comprises an FDX downstream frequency band 303. The FDX downstream frequency band 303 may comprise the same frequency band as the second upstream frequency band 301. Thus, the DOCSIS 4.0 device may be configured to transmit upstream signals to the network node 108 and receive downstream signals from the network node 108 via the same frequency band (e.g., about 108 MHZ to 492 MHZ).

To determine if a customer is able to replace the client device 102 with the DOCSIS 4.0 device themselves (e.g., using a GSK), or if a technician should be dispatched to perform a pro-installation of the DOCSIS 4.0 device, the server device 120 may estimate a transmit power (e.g., a required transmit power) that would be necessary for the DOCSIS 4.0 device, if the DOCSIS 4.0 device were to be installed at approximately the same location at the premises 101 at which the client device 102 is currently installed, to transmit one or more upstream signals to the network node 108 via the second upstream frequency band (e.g., second upstream frequency band 301) to achieve a threshold receive power at the network node 108. The threshold receive power may comprise a predetermined (e.g., configured) receive level set point (RLSP). The server device 120 may store or be able to access data indicative of the measured receive level of client devices 102, and adjust the RLSP in accordance with specific network instances.

The server device 120 may estimate the required transmit power based on (e.g., using) the first information and the second information. Estimating the required transmit power may comprise estimating an upstream path loss associated with the DOCSIS 4.0 device, if the DOCSIS 4.0 device were to be installed at approximately the same location at the premises 101 as the client device 102 is currently installed. The estimated upstream path loss associated with the DOCSIS 4.0 device may comprise an estimated path loss associated with upstream signals that may be transmitted by the DOCSIS 4.0 device to the network node 108 via the second upstream frequency band (e.g., second upstream frequency band 301).

The server device 120 may estimate the upstream path loss based on (e.g., using) the second information. For example, the server device 120 may estimate the upstream path loss based on determining a downstream path loss associated with the client device 102. Determining the downstream path loss associated with the client device 102 may comprise subtracting the downstream frequency response (e.g., frequency response 300) indicated by the second information from a known RF downstream transmit power spectrum profile (e.g., a known transmit power) associated with the network node 108. The RF downstream transmit power spectrum profile associated with the network node 108 may be a fixed, known setting that is accessible via network design data or node configuration.

As the second upstream frequency band that would be used by the DOCSIS 4.0 device at least partially overlaps with the downstream frequency band used by the client device 102, it may be assumed that the downstream path loss associated with the client device 102 is the same, or approximately the same, as the upstream path loss that the DOCSIS 4.0 device would face if the DOCSIS 4.0 device were to be installed at approximately the same location at the premises 101 as the client device 102 is currently installed. That is, the estimated upstream path loss associated with the DOCSIS 4.0 device may be equal to, or substantially equal to, the downstream path loss associated with the client device 102.

The server device 120 may estimate the required transmit power based on the first information and the estimated upstream path loss associated with the DOCSIS 4.0 device. The first information may be indicative of a transmit power (e.g., an initial transmit power) associated with upstream signals transmitted by the client device 102 to the network node 108 via the first upstream frequency band. Estimating the required transmit power based on the first information and the estimated upstream path loss associated with the DOCSIS 4.0 device may comprise estimating the transmit power that, in addition to the initial transmit power, would be necessary for the DOCSIS 4.0 device to overcome the estimated upstream path loss in the second frequency band to achieve the threshold receive power at the network node 108. The server device 120 may estimate the total required transmit power to be equal to the sum of the initial transmit power and the additional transmit power that would be necessary for the DOCSIS 4.0 device to overcome the estimated upstream path loss in the second upstream frequency band to achieve the threshold receive power at the network node 108.

The server device 120 may determine, based on the estimated transmit power, if the DOCSIS 4.0 device, installed at approximately the same location at the premises 101 as the client device 102 is currently installed, would be able to satisfy a threshold level of communication with the network node 108. The server device 120 may determine if the DOCSIS 4.0 device, installed at approximately the same location at the premises 101 as the client device 102 is currently installed, would be able to satisfy the threshold level of communication with the network node 108 based on comparing the estimated transmit power to a maximum upstream total composite power (TCP) power limitation associated with the DOCSIS 4.0 device. The maximum upstream TCP power limitation associated with the DOCSIS 4.0 device may indicate a maximum transmit power capability of the DOCSIS 4.0 device. The maximum upstream TCP power limitation associated with the DOCSIS 4.0 device in the FDX band may comprise, for example, 64.5 decibels relative to one millivolt (dBmV).

The server device 120 may determine that the DOCSIS 4.0 device, installed at approximately the same location at the premises 101 as the client device 102 is currently installed, would be able to satisfy the threshold level of communication with the network node 108 if the estimated transmit power is less than or equal to the maximum upstream TCP power limitation associated with the DOCSIS 4.0 device. If the server device 120 determines that the DOCSIS 4.0 device, installed at approximately the same location at the premises 101 as the client device 102 is currently installed, would be able to satisfy the threshold level of communication with the network node 108, then it may be estimated that all speeds the system is designed to support can be supported. If it is estimated that all speeds the system is designed to support can be supported, this may indicate that the customer is able to replace the client device 102 with the DOCSIS 4.0 device themselves (e.g., using a GSK). A GSK may be shipped to the premises 101 to enable the self-install of the DOCSIS 4.0 device.

The server device 120 may determine that the DOCSIS 4.0 device, installed at approximately the same location at the premises 101 as the client device 102 is currently installed, would not be able to satisfy the threshold level of communication with the network node 108 if the estimated transmit power is greater than the maximum upstream TCP power limitation associated with the DOCSIS 4.0 device. If the server device 120 determines that the DOCSIS 4.0 device, installed at approximately the same location at the premises 101 as the client device 102 is currently installed, would not be able to satisfy the threshold level of communication with the network node 108, this may indicate that the customer is not able to replace the client device 102 with the DOCSIS 4.0 device themselves (e.g., using a GSK). A technician may be dispatched to the premises 101 to install the DOCSIS 4.0 device.

Alternatively, if the server device 120 determines that the estimated transmit power is greater than the maximum upstream TCP power limitation associated with the DOCSIS 4.0 device, the server device 120 may perform an additional analysis to determine if the DOCSIS 4.0 device, installed at approximately the same location at the premises 101 as the client device 102 is currently installed, would be able to satisfy the threshold level of communication with the network node 108.

Performing the additional analysis may comprise estimating a maximum upstream speed associated with one or more upstream signals that may be transmitted by the DOCSIS 4.0 device to the network node 108 if the DOCSIS 4.0 device were to be installed at approximately the same location at the premises 101 as the client device 102 is currently installed. The estimated maximum upstream speed may be compared to a speed threshold. The speed threshold may be indicative of a speed tier that has been selected by the customer. If the estimated maximum upstream speed satisfies the speed threshold, this may indicate that the customer is able to replace the client device 102 with the DOCSIS 4.0 device themselves (e.g., using a GSK), even though the estimated transmit power is greater than the maximum upstream TCP power limitation associated with the DOCSIS 4.0 device. Conversely, if the estimated maximum upstream speed does not satisfy the speed threshold, this may indicate that the customer is not able to replace the client device 102 with the DOCSIS 4.0 device themselves (e.g., using a GSK). A technician may be dispatched to the premises 101 to install the DOCSIS 4.0 device.

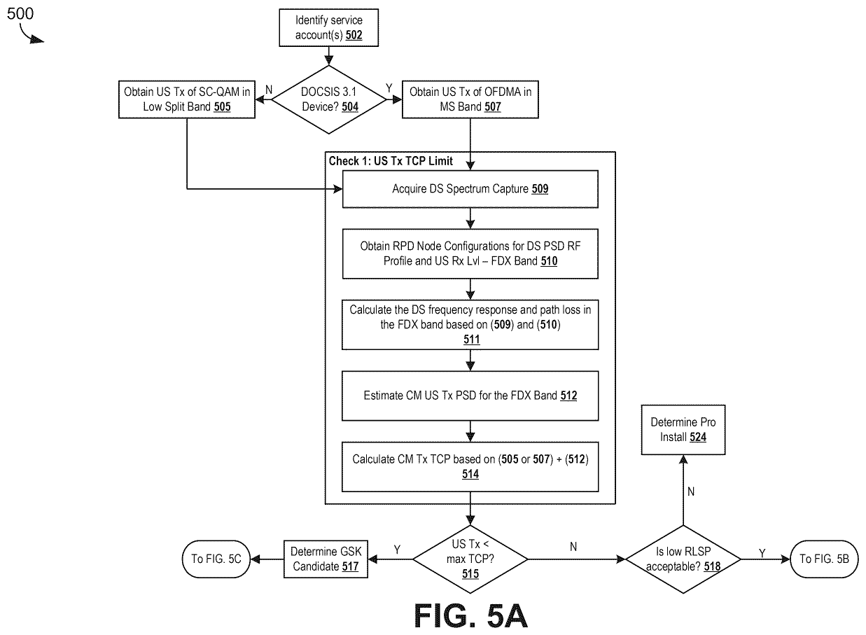

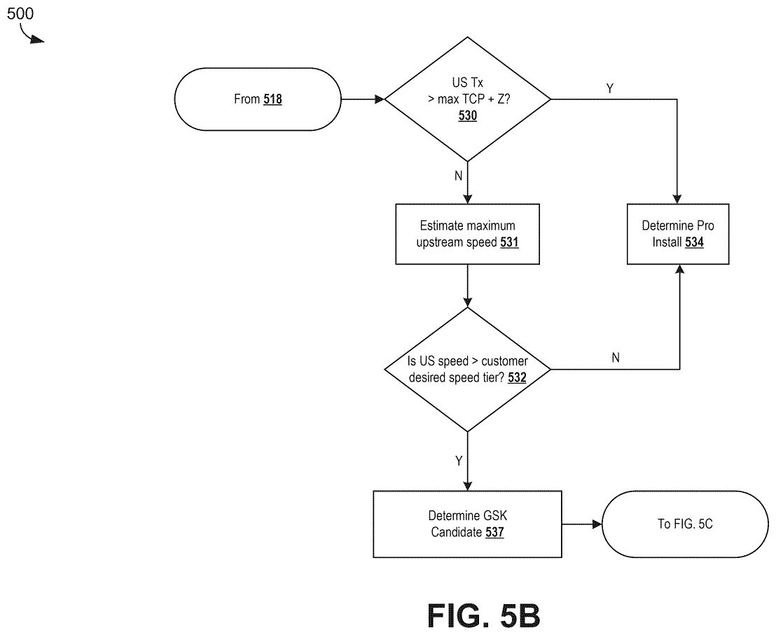

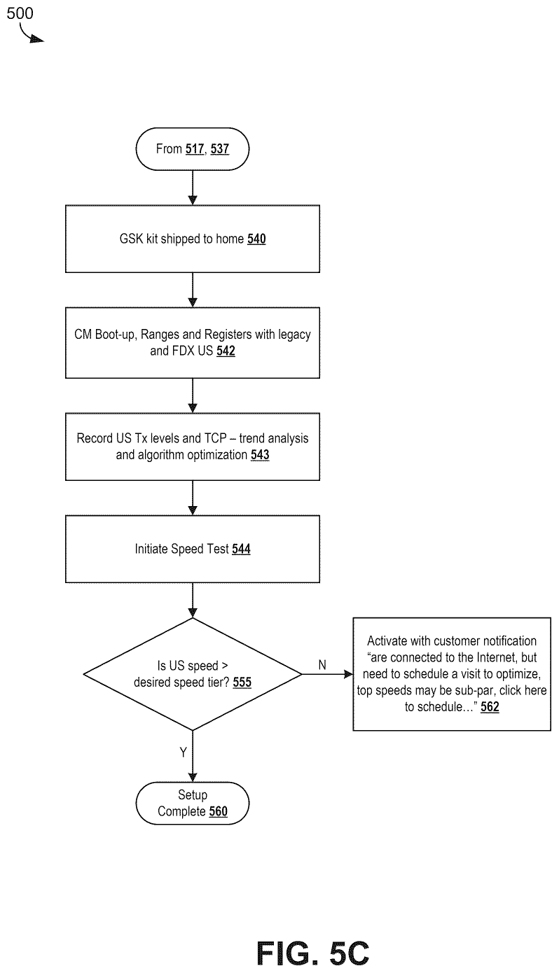

FIGS. 5A-C show an example method 500. The method 500 may comprise a computer implemented method for determining if a DOCSIS 4.0 device is a candidate for self-install. A system and/or computing environment, such as the system 100 of FIG. 1 and/or the computing environment of FIG. 9, may be configured to perform the method 500. For example, the server device 120 of FIG. 1 may be configured to perform some or all of the steps of method 500.

At 502, one or more service accounts associated with a first client device (e.g., client device 102) located at a premises (e.g., premises 101) may be identified. The service account(s) may indicate a device type associate with the first client device. For example, the service account(s) may indicate if the first client device comprises a client device that is compliant with DOCSIS 3.0 or a client device that is compliant with DOCSIS 3.1. At 504, it may be determined if the first client device is a DOCSIS 3.1 device. It may be determined if the first client device is a DOCSIS 3.1 device based on the device type information contained in the service account(s) or from querying the first device itself. If it is determined that the first client device is not a DOCSIS 3.1 device, the method 500 may proceed to 505. At 505, an upstream transmit power associated with Single Carrier Quadrature Amplitude Modulation (SC-QAM) signals transmitted by the first client device in the low-split band may be determined. Conversely, if it is determined that the first client device is a DOCSIS 3.1 device, the method 500 may proceed to 507. At 507, an upstream transmit power associated with Single Carrier Quadrature Amplitude Modulation (SC-QAM) signals or OFDMA signals transmitted by the first client device in the mid-split band may be determined. The upstream transmit power may be received from the first client device, regardless of whether the first client device is a DOCSIS 3.1 device, as part of the normal cable modem telemetry collection process. The low-split band or the mid-split band (whichever is applicable to the first client device) may be referred to as the first upstream frequency band associated with the first client device. After 505 or 507, the method 500 may proceed to 509.

At 509, a downstream spectrum capture may be acquired. The downstream spectrum capture may comprise an FBC. The FBC may be indicative of a frequency response associated with downstream signals received by the first client device from a network node via a downstream frequency band associated with the first client device. The frequency response may indicate a signal level versus frequency for the first client device across the entirety of the downstream bandwidth. The downstream spectrum capture may be received from the first client device as part of the normal cable modem telemetry collection process.

At 510, a Remote PHY Device (RPD) node configuration for the downstream PSD RF Profile may be obtained. The RPD node configuration for the downstream PSD RF Profile (e.g., the RF downstream transmit power spectrum profile) may be a known setting that is accessible via network design data or node configuration. Further, an RLSP of the network node in a second upstream frequency band (e.g., the DOCSIS 4.0 FDX band) may be obtained. The second upstream frequency band may at least partially overlap with the downstream frequency band associated with the first client device. The RLSP may indicate a desired upstream receive level at the network node in the second upstream frequency band. The RLSP may comprise a set value that is assumed to be flat over the upstream receive bandwidth.

At 511, the path loss and the frequency response of the path loss in the downstream frequency band (e.g., the downstream frequency response) may be determined based on the downstream spectrum capture acquired at 509 and the RF downstream transmit power spectrum profile obtained at 510. The downstream path loss and the frequency response of the downstream path loss in the downstream frequency band may be determined based on subtracting the RF downstream transmit power spectrum profile obtained at 510 from the downstream spectrum capture acquired at 509. Because the downstream frequency band at least partially overlaps with the second upstream frequency band (e.g., the DOCSIS 4.0 FDX band), this downstream path loss and frequency response may be the same as, or approximately the same as, the upstream path loss and frequency response that a second device, compliant with DOCSIS 4.0, would have to contend with in the second upstream frequency band (if the second device were to be installed at approximately the same location at the premises at which the first client device is currently installed).

At 512, an upstream transmit PSD (e.g., upstream transmit power spectral density) for the second upstream frequency band may be estimated. The estimated upstream transmit PSD may indicate the transmit power that, in addition to the transmit power of the first client device determined at 505 or 507, would be necessary for a second device, compliant with DOCSIS 4.0 and installed at approximately the same location at the premises at which the first client device is currently installed, to overcome the upstream path loss in the second upstream frequency band and achieve the RLSP of the network node (obtained at 510). At 514, a total required transmit power may be estimated. The total required transmit power may comprise the transmit power for the second device, compliant with DOCSIS 4.0 and installed at approximately the same location at the premises at which the first client device is currently installed, to transmit one or more upstream signals to the network node via the second upstream frequency band to achieve the RLSP of the network node may be estimated. The total required transmit power may be estimated based on adding the estimated upstream transmit PSD for the second upstream frequency band determined at 512 to the upstream transmit power of the first client device determined at 505 or 507.

At 515, it may be determined if the second device, compliant with DOCSIS 4.0 and installed at approximately the same location at the premises at which the first client device is currently installed, would be able to satisfy the threshold level of communication with the network node. It may be determined if the second device, compliant with DOCSIS 4.0 and installed at approximately the same location at the premises at which the first client device is currently installed, would be able to satisfy the threshold level of communication with the network node based on the estimated required transmit power determined at 514. For example, the estimated required transmit power determined at 514 may be compared to a maximum upstream TCP power limitation associated with the second device. The maximum upstream TCP power limitation associated with the second device may indicate a maximum transmit power capability of the second device. The maximum upstream TCP power limitation associated with the second device may comprise, for example, 64.5 dBmV in the FDX band.

If it is determined that the estimated required transmit power determined at 514 is less than or equal to the maximum upstream TCP power limitation associated with the second device, the method 500 may proceed to 517. At 517, it may be determined that the second device, if it were to be installed at approximately the same location at the premises as the first device is currently installed, would be able to satisfy the threshold level of communication with the network node and therefore be able to achieve all of the data speeds that the system is designed to achieve. This may indicate that a customer is able to replace the first device with the second device themselves (e.g., using a GSK). The method 500 may proceed to 540.

Conversely, if it is determined that the estimated required transmit power is greater than the maximum upstream TCP power limitation associated with the second device, the method 500 may proceed to 518. At 518, it may be determined if a low RLSP is acceptable. If a low RLSP is not acceptable, the method 500 may proceed to 524. At 524, it may be determined that the customer is not able to replace the first device with the second device themselves (e.g., using a GSK). A technician may need to be dispatched to the premises to install the second device. If a low RLSP is acceptable, the method 500 may proceed to 530.

At 530, it may be determined if the estimated required transmit power is within an acceptable range of the maximum upstream TCP power limitation associated with the second device. The estimated required transmit power may be within the acceptable range of the maximum upstream TCP power limitation of the estimated required transmit power is less than or equal to the sum of the maximum upstream TCP power limitation and a predetermined value Z. The predetermined value Z may comprise any value, such as 4 dBmV, 5 dBmV, 6 dBmV, 7 dBmV, or any other value. For example, if the maximum upstream TCP power limitation associated with the second device is 64.5 dBmV and the predetermined value Z is equal to 4 dBmV, the estimated required transmit power may be within the acceptable range of the maximum upstream TCP power limitation of the estimated required transmit power is less than or equal to 68.5 dBmV.

If it is determined that the estimated required transmit power is not within the acceptable range of the maximum upstream TCP power limitation associated with the second device, the method 500 may proceed to 534. At 534, it may be determined that the customer is not able to replace the first device with the second device themselves (e.g., using a GSK). A technician may need to be dispatched to the premises to install the second device. If it is determined that the estimated required transmit power is within the acceptable range of the maximum upstream TCP power limitation associated with the second device, the method 500 may proceed to 531.

At 531, a maximum upstream speed may be estimated. The maximum upstream speed may be estimated based on determining a capacity loss associated with the lower RLSP. For example, one profile of modulation efficiency may be lost for every three dB of RLSP that is lost, and a loss of one profile of modulation efficiency may cause approximately a ten percent capacity loss. Based on the determined capacity loss, an available capacity for the customer may be determined. The available capacity for the customer may be indicative of the maximum upstream speed associated with one or more upstream signals transmitted by the second device, if it were to be installed at approximately the same location at the premises as the first device is currently installed, to the network node via the second upstream frequency band to achieve the lower RLSP of the network node.

The maximum upstream speed may be estimated based on the following equation: Speed (Mbps)=[(QAM−[X]) (FDX BW) (OFDMA OH)]+(MS Capacity)] (Estimate Error Margin). X may be indicative of the capacity loss. For example, X may have a value of either one, two, or three. X may have a value of +1 for every 3 dB the RLSP is below the desired RLSP. For example, X may have a value of +1 for every 3 dB the estimated required transmit power is above the maximum upstream TCP power limitation. QAM may represent a nominal bandwidth (BW) efficiency assumption that is empirically derived and may be optimized continuously with data. QAM may have a value of 11, 10.5, 10, 9.5, 9, etc. FDX BW may be given in units of MHz and may represent a defined FDX spectrum allocation (e.g., 276 MHz to 384 MHz to 576 MHZ). OFDMA OH may represent the Orthogonal Frequency-Division Multiple Access (OFDMA) scale overhead of phy-to-net throughput (e.g., empirically determined at 0.68). The Estimate Error Margin may be assigned a value of 0.9 to represent a 10% error margin. The value of MS Capacity may vary with configurations of SC-QAM+OFDMA. An example value of MS Capacity, which may be determined empirically, is 450 Mbps.

At 532, it may be determined if the estimated maximum upstream speed is greater than a customer desired speed tier. If the estimated maximum upstream speed is not greater than the customer desired speed tier, the method 500 may proceed to 534. At 534, it may be determined that the customer is not able to replace the first device with the second device themselves (e.g., using a GSK). A technician may need to be dispatched to the premises to install the second device. If the estimated maximum upstream speed is greater than the customer desired speed tier, the method 500 may proceed to 537. At 537, it may be determined that the second device, if it were to be installed at approximately the same location at the premises as the first device is currently installed, would be able to satisfy the threshold level of communication with the network node. This indicate that a customer is able to replace the first device with the second device themselves (e.g., using a GSK). The method 500 may proceed to 540.

At 540, the GSK kit may be shipped to the premises. The customer may be able to use the GSK to replace the first device with the second device (e.g., to install the second device at approximately the same location at the premises as the first device was installed). At 542, the installed second device may be powered on. The installed second device may range and register with the first upstream frequency band and the second upstream frequency band. At 543, the upstream transmit levels associated with the installed second device may be recorded. The upstream TCP associated with the installed second device may be recorded. Trends associated with the upstream transmit levels and the upstream TCP may be analyzed and algorithms may be optimized. At 544, a speed test may be initiated by the installed second device. The speed test may be initiated to determine if the upstream speed associated with the installed second device is within acceptable limits. At 555, it may be determined if the upstream speed associated with the installed second device is greater than a desired speed tier (e.g., a speed tier selected by the customer). If the upstream speed associated with the installed second device is greater than the desired speed tier, the method 500 may proceed to 560. At 560, the setup of the second device may be complete.

Conversely, if the upstream speed associated with the installed second device is less than or equal to the desired speed tier, the method 500 may proceed to 562. At 562, a first notification may be sent to the customer. The first notification may indicate that the upstream speed associated with the installed second device is sub-par. The first notification may invite the customer to schedule a technician visit for optimization of the second device. A second notification may be sent to operations to identify the failed self-install. The installed second device may still be online while the customer waits for technician optimization, but the installed second device may only be able to achieve 1.4 Gbps instead of 2 Gbps, for example.

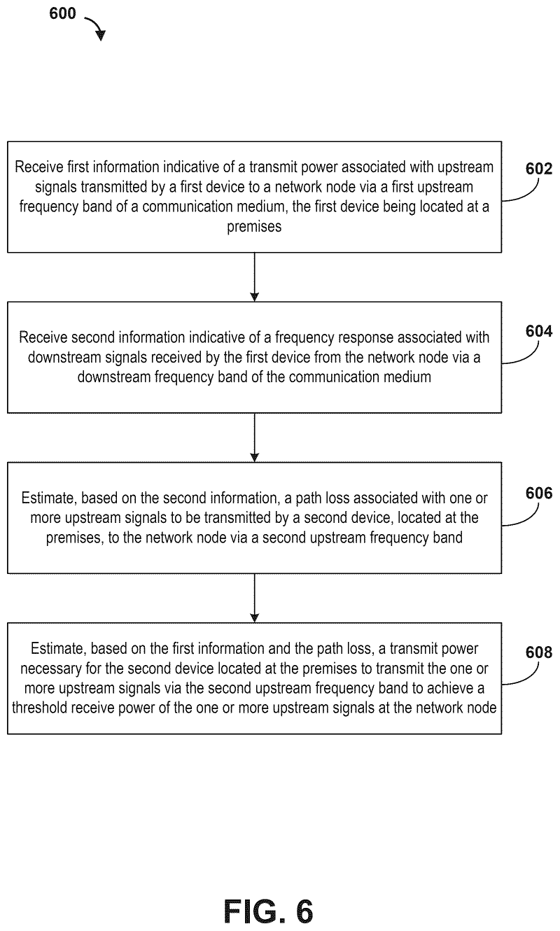

FIG. 6 is an example method 600. The method 600 may comprise a computer implemented method for estimating a required transmit power. A system and/or computing environment, such as the system 100 of FIG. 1 and/or the computing environment of FIG. 9, may be configured to perform the method 600. For example, the server device 120 of FIG. 1 may be configured to perform the method 600.

At 602, first information may be received. The first information may be indicative of a transmit power associated with upstream signals transmitted by a first device to a network node via a first upstream frequency band of a communication medium. The first device may be located at a premises. The first device may comprise a modem compliant with DOCSIS 3.0 or DOCSIS 3.1. The first upstream frequency band may comprise frequencies in a range of about 5 MHz to 85 MHz. The communication medium may comprise a HFC cable connection between the network node and the first device. The network node may comprise a DAA node. The first information may be received from the first device via the network node. The first device may periodically (e.g., twice per day) send the first information. The first device may periodically send the first information based on (e.g., in response to) a request message sent to the first device.

At 604, second information may be received. The second information may be indicative a frequency response associated with downstream signals received by the first device from the network node via a downstream frequency band of the communication medium. The downstream frequency band may be different from the first upstream frequency band. The downstream frequency band may comprise frequencies in a range of about 100 MHz to 1 GHz. The second information may be indicative of received signal levels associated with the downstream signals received by the first device from the network node via the downstream frequency band of the communication medium. The second information may be received from the first device via the network node. The first device may periodically (e.g., twice per day) send the second information. The first device may periodically send the second information based on (e.g., in response to) a request message sent to the first device.

At 606, a path loss associated with one or more upstream signals to be transmitted by a second device, if it were to be installed at approximately the same location at the premises as the first device, to the network node via a second upstream frequency band, may be estimated. The second device may comprise a modem compliant with DOCSIS 4.0. The second upstream frequency band may at least partially overlap the downstream frequency band. The second upstream frequency band may comprise frequencies in a range of about 108 MHz to 492 MHz. The path loss may be estimated based on the second information. For example, the path loss may be estimated based on the second information and a known RF configuration for the network node.

At 608, a transmit power may be estimated. The transmit power may comprise the transmit power necessary for the second device, if it were to be installed at approximately the same location at the premises as the first device, to transmit the one or more upstream signals to the network node via the second upstream frequency band to achieve a threshold receive power of the one or more upstream signals at the network node. The transmit power may be estimated based on the first information and the estimated path loss.

It may be determined, based on the estimated transmit power, if the second device, installed at approximately the same location at the premises, would be able to satisfy a threshold level of communication with the network node. The second device, installed at approximately the same location at the premises, may be able to satisfy the threshold level of communication with the network node if the estimated transmit power is less than or equal to a maximum upstream TCP power associated with the second device. If the estimated transmit power is greater than the maximum upstream TCP associated with the second device, it may be determined if an estimated speed associated with the one or more upstream signals transmitted by the second device, installed at approximately the same location at the premises as the first device, to the network node via the second upstream frequency band satisfies a speed threshold. The second device, installed at approximately the same location at the premises, may be able to satisfy the threshold level of communication with the network node if the estimated speed satisfies the speed threshold. The second device, installed at approximately the same location at the premises, may not be able to satisfy the threshold level of communication with the network node if the estimated speed does not satisfy the speed threshold.

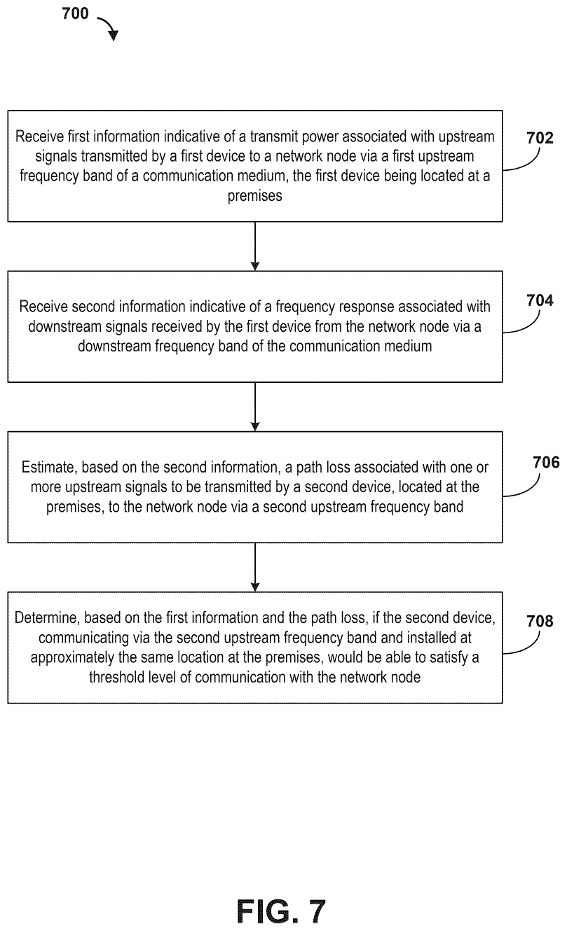

FIG. 7 is an example method 700. The method 700 may comprise a computer implemented method for estimating a required transmit power. A system and/or computing environment, such as the system 100 of FIG. 1 and/or the computing environment of FIG. 9, may be configured to perform the method 700. For example, the server device 120 of FIG. 1 may be configured to perform the method 700.

At 702, first information may be received. The first information may be indicative of a transmit power associated with upstream signals transmitted by a first device to a network node via a first upstream frequency band of a communication medium. The first device may be located at a premises. The first device may comprise a modem compliant with DOCSIS 3.0 or DOCSIS 3.1. The first upstream frequency band may comprise frequencies in a range of about 5 megahertz (MHz) to 85 MHz. The communication medium may comprise a hybrid fiber coax (HFC) cable connection between the network node and the first device. The network node may comprise a DAA node. The first information may be received from the first device via the network node. The first device may periodically (e.g., twice per day) send the first information. The first device may periodically send the first information based on (e.g., in response to) a request message sent to the first device.

At 704, second information may be received. The second information may be indicative a frequency response associated with downstream signals received by the first device from the network node via a downstream frequency band of the communication medium. The downstream frequency band may be different from the first upstream frequency band. The downstream frequency band may comprise frequencies in a range of about 100 MHz to 1 GHz. The second information may be received from the first device via the network node. The second information may be indicative of received signal levels associated with the downstream signals received by the first device from the network node via the downstream frequency band of the communication medium. The first device may periodically (e.g., twice per day) send the second information. The first device may periodically send the second information based on (e.g., in response to) a request message sent to the first device.

At 706, a path loss associated with one or more upstream signals to be transmitted by a second device, if it were to be installed at approximately the same location at the premises as the first device, to the network node via a second upstream frequency band, may be estimated. The second device may comprise a modem compliant with DOCSIS 4.0. The second upstream frequency band may at least partially overlap the downstream frequency band. The second upstream frequency band may comprise frequencies in a range of about 108 MHz to 492 MHz. The path loss may be estimated based on the second information. For example, the path loss may be estimated based on the second information and a known RF configuration for the network node.

At 708, it may be determined if the second device, communicating via the second upstream frequency band and installed at approximately the same location at the premises as the first device, would be able to satisfy a threshold level of communication with the network node. It may be determined if the second device, communicating via the second upstream frequency band and installed at approximately the same location at the premises as the first device, would be able to satisfy the threshold level of communication with the network node based on the first information and the path loss.

It may be determined if the second device, communicating via the second upstream frequency band and installed at approximately the same location at the premises as the first device, would be able to satisfy the threshold level of communication with the network node based on estimating a transmit power necessary for the second device, if it were to be installed at approximately the same location at the premises as the first device, to transmit one or more upstream signals to the network node via the second upstream frequency band to achieve a threshold receive power at the network node. The transmit power may be estimated based on the first information and the estimated path loss.

The second device, installed at approximately the same location at the premises, may be able to satisfy the threshold level of communication with the network node if the estimated transmit power is less than or equal to a maximum upstream TCP power associated with the second device. If the estimated transmit power is greater than the maximum upstream TCP associated with the second device, it may be determined if an estimated speed associated with the one or more upstream signals transmitted by the second device, installed at approximately the same location at the premises as the first device, to the network node via the second upstream frequency band satisfies a speed threshold. The second device, installed at approximately the same location at the premises, may be able to satisfy the threshold level of communication with the network node if the estimated speed satisfies the speed threshold. The second device, installed at approximately the same location at the premises, may not be able to satisfy the threshold level of communication with the network node if the estimated speed does not satisfy the speed threshold.

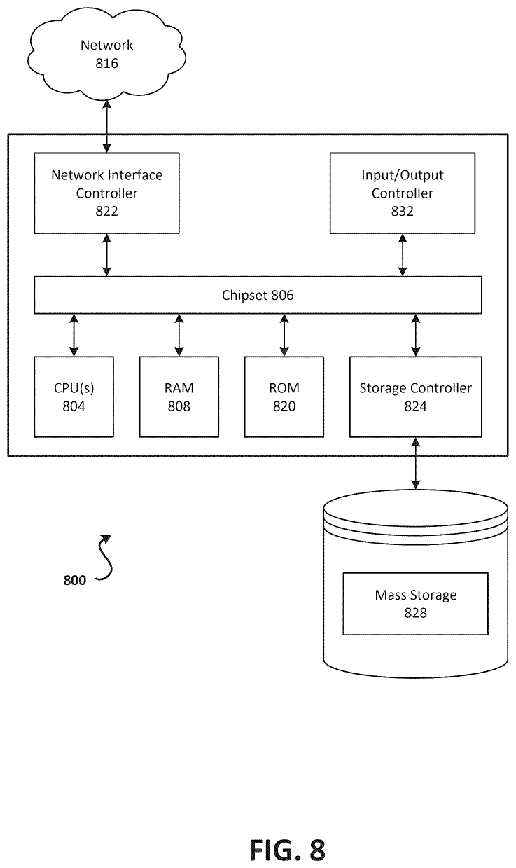

FIG. 8 is example computing device 800 that may represent any of the various devices or entities shown in FIG. 1, including, for example, the client device 102 or the server device 120, or any of the various devices or entities described in FIGS. 2-7, such as the second device. That is, the computing device 800 shown in FIG. 8 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 5-7.

The computing device 800 may include a baseboard, or “motherboard,” which is a printed circuit board to which a multitude of components or devices may be connected by way of a system bus or other electrical communication paths. One or more central processing units (CPUs or “processors”) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s). The GPU(s) may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random-access memory (RAM) 808 used as the main memory in the computing device 800. The chipset 806 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems of the system 80. The chipset 806 may include functionality for providing network connectivity through a network interface controller (NIC) 822. A NIC 822 may be capable of connecting the computing device 800 to other computing nodes over the system 80. It should be appreciated that multiple NICs 822 may be present in the computing device 800, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 80. For example, the NIC 822 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 800 may be connected to a mass storage device 828 (e.g., first storage 121) that provides non-volatile storage (i.e., memory) for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 5-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving first information indicative of a transmit power associated with upstream signals transmitted by a first device to a network node via a first upstream frequency band of a communication medium, wherein the first device is located at a premises;
receiving second information indicative of a frequency response and received signal levels associated with downstream signals received by the first device from the network node via a downstream frequency band of the communication medium, wherein the downstream frequency band is different from the first upstream frequency band; and
estimating, based on the first information and the second information, a transmit power necessary for a second device located at the premises to transmit one or more upstream signals to the network node via a second upstream frequency band to achieve a threshold receive power of the one or more upstream signals at the network node, wherein the second upstream frequency band at least partially overlaps the downstream frequency band.

2. The method of claim 1, wherein the first upstream frequency band comprises frequencies in a range of about 5 megahertz (MHz) to 85 MHz, wherein the downstream frequency band comprises frequencies in a range of about 100 MHz to 1 gigahertz (GHz), and wherein the second upstream frequency band comprises frequencies in a range of about 108 MHz to 489 MHz.

3. The method of claim 1, wherein the communication medium comprises one of: a coaxial cable connection between the network node and the first device, or a hybrid fiber coax (HFC) cable connection between the network node and the first device.

4. The method of claim 1, wherein estimating, based on the first information and the second information, the transmit power necessary for the second device located at the premises to transmit the one or more upstream signals to the network node via the second upstream frequency band to achieve the threshold receive power of the one or more upstream signals at the network node comprises:
estimating, based on the second information, a path loss associated with the one or more upstream signals transmitted by the second device, located at the premises, to the network node via the second upstream frequency band; and
estimating, based on the first information and the path loss, the transmit power necessary for the second device located at the premises to transmit the one or more upstream signals to the network node via the second upstream frequency band to achieve the threshold receive power of the one or more upstream signals at the network node.

5. The method of claim 1, wherein the first device is installed at a location at the premises, and wherein the method further comprises:
determining, based on the estimated transmit power, if the second device, installed at approximately the same location at the premises, would be able to satisfy a threshold level of communication with the network node.

6. The method of claim 5, wherein the second device, installed at approximately the same location at the premises, would be able to satisfy the threshold level of communication with the network node if the estimated transmit power is less than or equal to a maximum upstream total composite power (TCP) power associated with the second device.

7. The method of claim 5, wherein determining if the second device, installed at approximately the same location at the premises, would be able to satisfy the threshold level of communication with the network node comprises:
based on determining that the estimated transmit power is greater than a maximum upstream total composite power (TCP) associated with the second device, determining if a speed associated with the one or more upstream signals transmitted by the second device, located at the premises, to the network node via the second upstream frequency band satisfies a speed threshold,
wherein the second device, installed at approximately the same location at the premises, would be able to satisfy the threshold level of communication with the network node if the speed satisfies the speed threshold.

8. The method of claim 1, wherein the first device comprises a modem compliant with DOCSIS 3.0 or DOCSIS 3.1, and wherein the second device comprises a modem compliant with DOCSIS 4.0.

9. The method of claim 1, wherein the network node comprises a Distributed Access Architecture (DAA) node.

10. The method of claim 1, wherein the first information and the second information are received from the first device, based on a request message sent to the first device.

11. A method comprising:
receiving first information indicative a transmit power associated with upstream signals transmitted by a first device to a network node via a first upstream frequency band of a communication medium, wherein the first device is located at a premises;
receiving second information indicative of a frequency response and received signal levels associated with downstream signals received by the first client device from the network node via a downstream frequency band of the communication medium, wherein the downstream frequency band is different from the first upstream frequency band; and
determining, based on the first information and the second information, if a second device, communicating via a second upstream frequency band and installed at approximately the same location at the premises, would be able to satisfy a threshold level of communication with the network node, wherein the second upstream frequency band at least partially overlaps the downstream frequency band.

12. The method of claim 11, wherein the first upstream frequency band comprises frequencies in a range of about 5 megahertz (MHz) to 85 MHz, wherein the downstream frequency band comprises frequencies in a range of about 100 MHz to 1 gigahertz (GHz), and wherein the second upstream frequency band comprises frequencies in a range of about 108 MHz to 489 MHz.

13. The method of claim 11, wherein determining, based on the first information and the second information, if a second device, communicating via the second upstream frequency band and installed at approximately the same location at the premises, would be able to satisfy the threshold level of communication with the network node comprises:
estimating, based on the first information and the second information, a transmit power necessary for the second device located at the premises to transmit the one or more upstream signals to the network node via the second upstream frequency band to achieve the threshold receive power of the one or more upstream signals at the network node comprises; and
determining, based on the estimated transmit power, if the second device, installed at approximately the same location at the premises, would be able to satisfy the threshold level of communication with the network node.

14. The method of claim 13, wherein the second device, installed at approximately the same location at the premises, would be able to satisfy the threshold level of communication with the network node if the estimated transmit power is less than or equal to a maximum upstream total composite power (TCP) power associated with the second device.

15. The method of claim 13, wherein determining, based on the estimated transmit power, if the second device, installed at approximately the same location at the premises, would be able to satisfy the threshold level of communication with the network node comprises:
based on determining that the estimated transmit power is greater than a maximum upstream total composite power (TCP) associated with the second device, determining if a speed associated with the one or more upstream signals transmitted by the second device, located at the premises, to the network node via the second upstream frequency band satisfies a speed threshold,
wherein the second device, installed at approximately the same location at the premises, would be able to satisfy the threshold level of communication with the network node if the speed satisfies the speed threshold.

16. A method comprising:
receiving first information indicative of a transmit power associated with upstream signals transmitted by a first device to a network node via a first upstream frequency band of a communication medium, wherein the first device is located at a premises;
receiving second information indicative of a frequency response associated with downstream signals received by the first device from the network node via a downstream frequency band of the communication medium, wherein the downstream frequency band is different from the first upstream frequency band;
estimating, based on the second information, a path loss associated with one or more upstream signals to be transmitted by a second device, located at the premises, to the network node via a second upstream frequency band, wherein the second upstream frequency band at least partially overlaps the downstream frequency band; and
estimating, based on the first information and the path loss, a transmit power necessary for the second device located at the premises to transmit the one or more upstream signals to the network node via the second upstream frequency band to achieve a threshold receive power of the one or more upstream signals at the network node.

17. The method of claim 16, wherein the first upstream frequency band comprises frequencies in a range of about 5 megahertz (MHz) to 85 MHz, wherein the downstream frequency band comprises frequencies in a range of about 100 MHz to 1 gigahertz (GHz), and wherein the second upstream frequency band comprises frequencies in a range of about 108 MHz to 492 MHz.

18. The method of claim 16, wherein the first device is installed at a location at the premises, and wherein the method further comprises:
determining, based on the estimated transmit power, if the second device, installed at approximately the same location at the premises, would be able to satisfy a threshold level of communication with the network node.

19. The method of claim 18, wherein the second device, installed at approximately the same location at the premises, would be able to satisfy the threshold level of communication with the network node if the estimated transmit power is less than or equal to a maximum upstream total composite power (TCP) power associated with the second device.

20. The method of claim 18, wherein determining if the second device, installed at approximately the same location at the premises, would be able to satisfy the threshold level of communication with the network node comprises:
based on determining that the estimated transmit power is greater than a maximum upstream total composite power (TCP) associated with the second device, determining if a speed associated with the one or more upstream signals to be transmitted by the second device, located at the premises, to the network node via the second upstream frequency band satisfies a speed threshold,
wherein the second device, installed at approximately the same location at the premises, would be able to satisfy the threshold level of communication with the network node if the speed satisfies the speed threshold.
